(19) United States
(12) Patent Application Publication
(10) Pub. No.: US 2006/0071542 A1
(43) Pub. Date: Apr. 6, 2006

(54) Hydraulic park pawl brake system

(76) Inventors: Toby Lichtensteiger, Port Washington, WI (US); John Schlintz, Milwaukee, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/958,633

(22) Filed: Oct. 5, 2004

(51) Int. Cl. B60T 17/16

(52) U.S. Cl. 303/89; 188/265; 188/344

(57) ABSTRACT

A handle bar master cylinder assembly for supplying pressurized hydraulic fluid through a brake line to actuate a brake in a vehicle. The assembly comprises a master cylinder having a master cylinder body defining a hydraulic fluid reservoir, a reciprocating master cylinder piston located within a hydraulic fluid reservoir, a handle bar attachment bracket connected to the master cylinder body and having a park pawl engagement section, a hand brake lever rotatably secured to the handle bar attachment bracket and in abutting contact with the reciprocating master cylinder piston, and a park pawl pivotably secured to the hand brake lever, the park pawl having an end engageable with the park pawl engagement section of the handle bar attachment bracket to maintain the brake lever in an applied position. When the pawl is set, a park pawl compensation flexure occurs due to a change in hydraulic fluid temperature.

### BACKGROUND AND SUMMARY OF THE INVENTION

The present invention relates generally to hydraulically held park brake systems, and more specifically, to a park pawl accumulator (PPA) for a service brake as part of a hydraulic brake system.

Typical hydraulic brake systems in applications such as ATV and snowmobile use a hydraulically held park brake. The service brake has a lever that the operator moves to apply pressure hydraulically to the brake caliper(s). The hydraulically held park brake operates by locking the service brake lever in the applied position. Typically this is accomplished by use of a pawl that is connected to the service brake lever that engages into the body of the master cylinder in such a way that the service brake lever remains in the position to which it was moved by the operator. The problem with this method is that when there is a change in temperature, the brake fluid expands or contracts (according to whether the temperature increases or decreases, respectively) thus changing the pressure in the brake system, and consequently, the brake torque exerted by the brake caliper. This is an issue, since there can be reduction in pressure such that there is insufficient brake torque to hold the vehicle in place (as on a grade). Conversely, when the pressure increases due to increase in temperature, the pressure in the brake system can increase so that damage to the brake components can occur.

It has been found that current products in the brake industry do not adequately address the problem of uncontrolled hydraulic brake pressure changes due to temperature changes. Moreover, current solutions do not provide any cost-effective solutions that are commercially viable for the industry.

A similar function to the park pawl can be accomplished by installing a separate hydraulic accumulator in the system which is typically done in (usually non-brake-related) hydraulic systems of much greater cost, space, complexity, and not in applications on ATVs or snowmobiles. The accumulator comprises a cylinder that has a spring pushing on a piston, with a seal on the piston that isolates the side of the piston where the spring resides from the hydraulic fluid on the “working” side of the piston. Obviously, this system is more expensive, and also introduces more failure modes, as there is another part inside of the hydraulic system.

Therefore, there is a need for a park pawl that has some capacity to absorb the additional pressures created from temperature increase of hydraulic brake fluid. Such a deflection capability would be necessary to handle the increase and decrease in brake pressure, and such a park pawl would be seen as beneficial to the brake industry.

Additional benefits would accrue from such a solution that could be implemented on a low-cost basis and without the need for additional separate hydraulic accumulators. Moreover, a need exists for a solution that minimizes the number of failure modes associated with the hydraulic system with a simple, low space solution.

The invention contemplates solutions to the above-identified problems and insufficiencies substantially in accordance with the foregoing summary.

### BRIEF DESCRIPTION OF THE DRAWINGS

A preferred exemplary embodiment of the invention is illustrated in the accompanying drawings in which like reference numerals represent like parts throughout, and in which:

FIG. 1 is a perspective view of a vehicle for use with the present invention;

FIG. 2 is a perspective view of a hand operated hydraulic brake system for use with the vehicle of FIG. 1;

FIG. 3 is an exploded view of the hand operated hydraulic brake of FIG. 2;

FIG. 4 is a sectional view of the hydraulic fluid system taken along line 4-4 of FIG. 2;

FIG. 5 is a partial schematic of a hand operated hydraulic brake system;

FIG. 6 is the hand operated hydraulic brake system of FIG. 5 showing the brake being applied;

FIG. 7 is the hand operated hydraulic brake system of FIG. 6 showing the park pawl being set;

FIG. 8 is the hand operated hydraulic brake system of FIG. 7 showing the additional movement of the park brake due to brake fluid expansion due to temperature increase; and

FIG. 9 is an enlarged view taken along 9-9 of FIG. 8 showing deflection of the park pawl due to brake fluid expansion due to temperature increase;

### DETAILED DESCRIPTION OF THE INVENTION

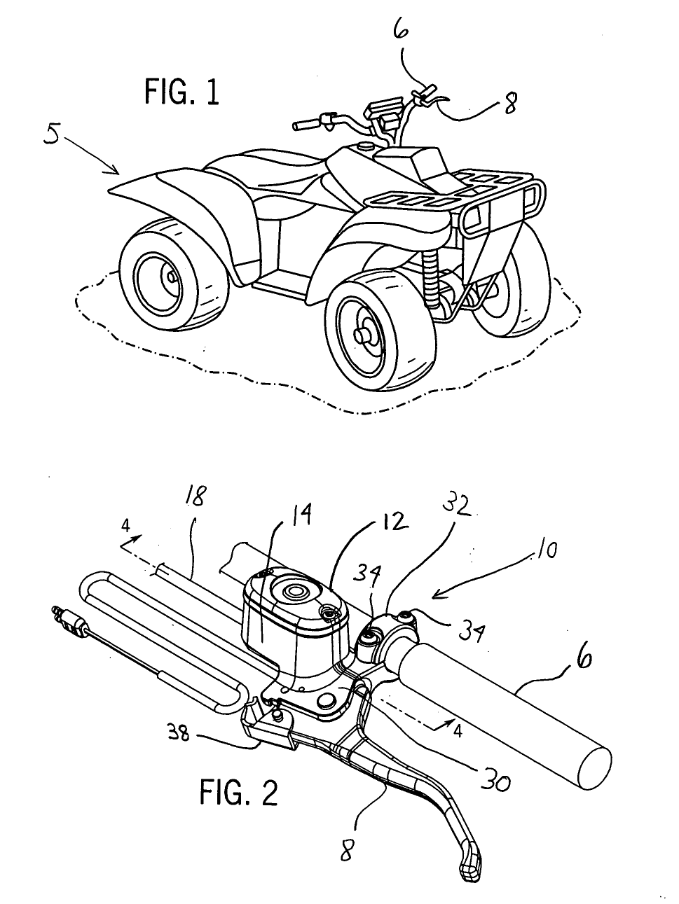

FIG. 1 is a perspective view of a vehicle for use with the present invention and FIG. 2 is a perspective view of a hand operated hydraulic brake system for use with the vehicle of FIG. 1. Referring to FIGS. 1-2, a vehicle 5 is shown for use with the present invention. Although a specific vehicle is shown as an all terrain vehicle (ATV), other types of vehicles, including snowmobiles or other powersports or off-road vehicles, are contemplated for use with the present invention. The present invention is used in a handbrake portion of vehicle 5 used for maintaining the vehicle 5 in a parked capacity, also called a park brake that includes a grip handle 6 used with brake lever 8 and against which hand pressure is applied to force the brake lever 8 towards the handle 6 in a generally known manner to stop vehicle 5. A left side vehicle handbrake is shown.

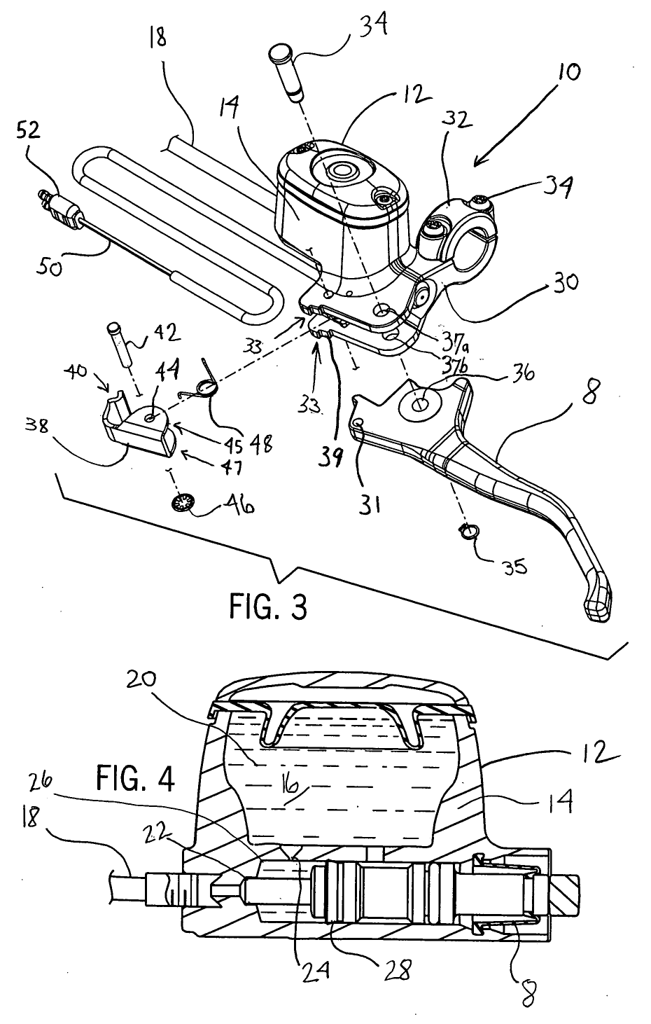

A hand operated hydraulic brake assembly 10 used with a vehicle such as vehicle 5 is shown in more detail in FIGS. 2-4. It is noted that a left handle brake lever system is shown, but that a right handle configuration is also contemplated with the components in a mirror configuration from that shown. The hand operated hydraulic brake assembly or master cylinder assembly 10 is used for supplying pressurized hydraulic fluid through a brake line to actuate a brake in a vehicle. Assembly 10 includes a master cylinder 12 having a master cylinder body 14 defining a hydraulic fluid reservoir 16. The reservoir contains (along with the brake line 18) a substantial portion of hydraulic fluid 20 that provide the hydraulic pressure for the braking function. A reciprocating master cylinder piston 22, which is located below the hydraulic fluid reservoir 16, pressurizes the hydraulic fluid to actuate the brake. This occurs by movement of the hydraulic fluid from reservoir 16 passing through port timing hole 24 into piston chamber 26, where the hydraulic fluid is drawn into the brake line 18 and pressurized as the piston seal 28 crosses the port timing hole 24, as occurs during brake actuation.

Still referring to FIGS. 2-4, a handle bar attachment bracket 30 includes a handle bar clamping portion 32 for receiving a handle bar therethrough to be secured with securing elements 34. Handle bar attachment bracket 30 is securably connected to the master cylinder body 14. Attachment bracket 30 and master cylinder body 14 may be machined so as to be a unitary cast or molded part or otherwise be of an integral construction. A hand brake lever 8 is rotatably secured as by pin 34 to the handle bar attachment bracket 30 through handle bar lever aperture 36 with co-aligning handle bar attachment bracket apertures 37a-b, which are in abutting contact with the reciprocating master cylinder piston 22, the lever rotatable to an applied position for braking of the vehicle. Attachment bracket 30 includes park pawl engagement sections 33. Pin 34 engages ring 35.

A park pawl 38 is pivotably secured to the hand brake lever 8. As used herein, the “park pawl” is any hinged or pivoted device that can fit into a notch or other engagement section so as to permit or impart motion of the engagement section in one direction and prevent motion of the section in the other direction as that device is used in the parking function. Park pawl 38 includes an end 40 that is engageable with the park pawl engagement section 33 of the handle bar attachment bracket 30 to lock the brake lever 8 in a locked position when the lever is in the applied position. The bracket park pawl engagement section includes a notched portion 39. More specifically, pin 42 is passable through hole 44 in park pawl ear section 45, with an identical hole in opposing ear section 47 to engage retainer ring 46. Finally spring clip 48 fits between ear sections 45 and 47 and permits the pin 42 to pass therethrough (passing through the holes in the ear section), hole 31 in lever 8, and engage the retainer 46. The spring clip provides necessary tensioning and bias against the movement of lever 8. Lever 8 includes should 49 which is in abutting contact with piston 22.

Advantageously, the pawl 38, spring clip 48 and pin 42 may be sold as part of a replacement or service kit, and in this respect, sold as an aftermarket package, which may also include lever 8.

Other features associated with the braking function and which may be used in conjunction with the present invention include brake light wiring 50 and connectors 52 for providing brake lights when the brake lever 8 is actuated.

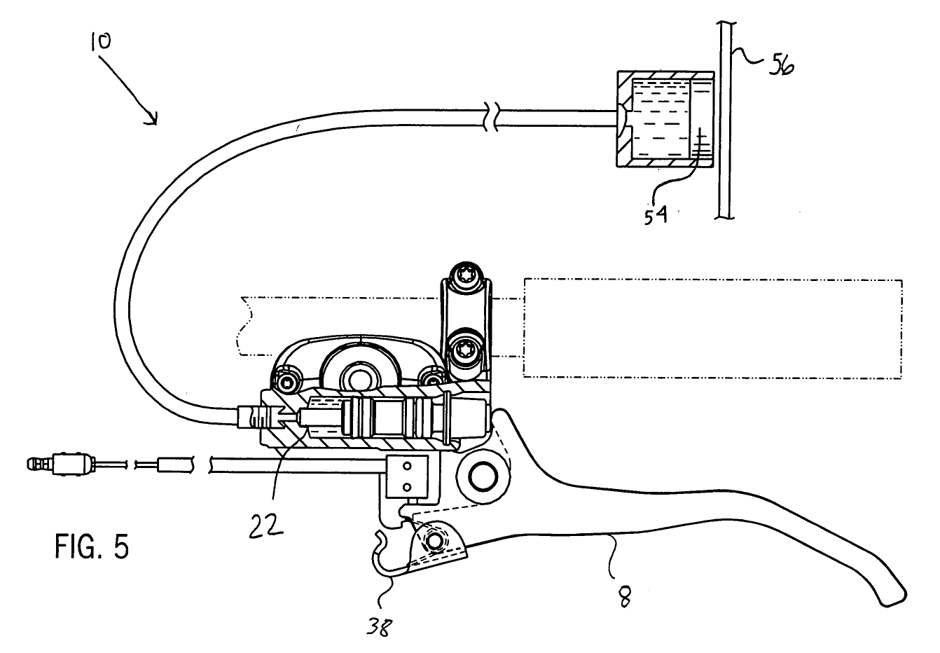

For FIGS. 5-8, a piston 54 is shown in operation with a schematic representation of a disc brake rotor 56. For simplicity, other mechanical structures including the brake pad and caliper are not specifically shown, although understood to be part of the operation of the piston.

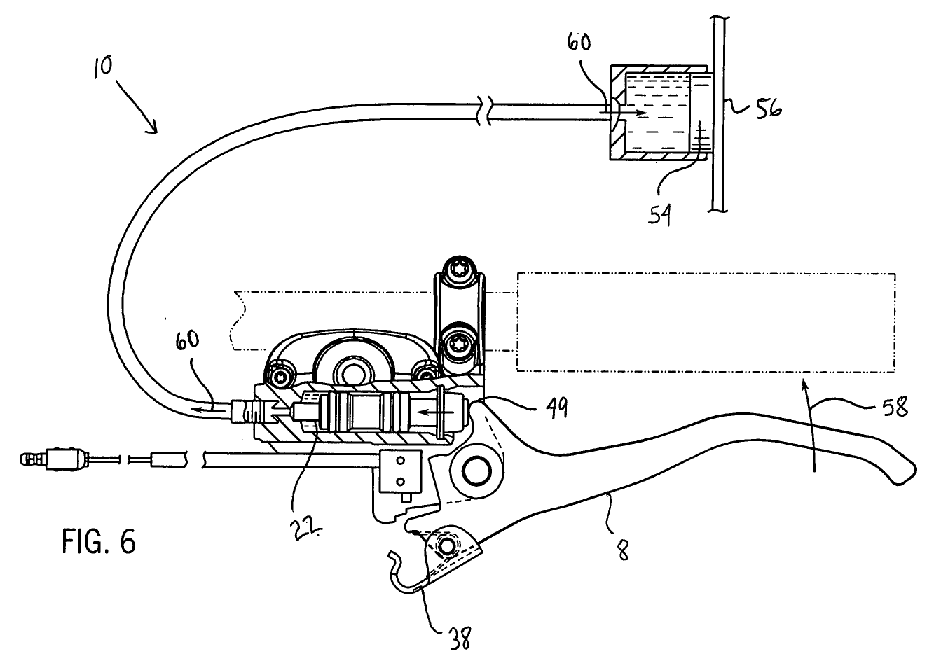

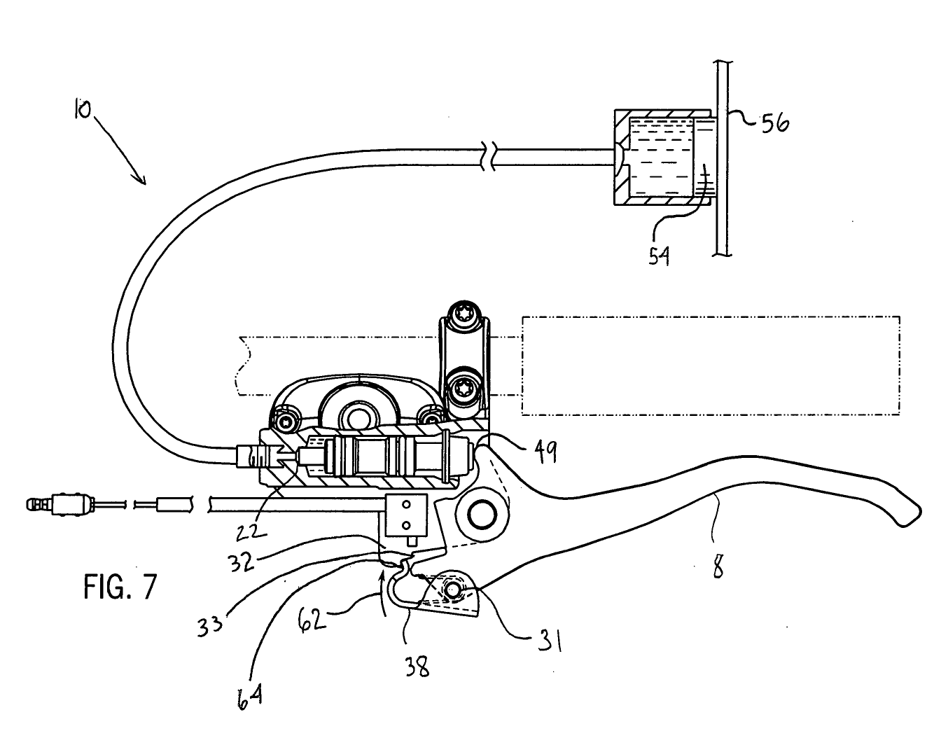

Brake lever 8 is moved to applied position (FIG. 6), as indicated by arrow 58, from its at rest position shown in FIG. 5. The applied position occurs during a normal braking operation. In typical braking, since lever 8 is in abutting contact with the master cylinder piston 22 via shoulder 49, when the lever is moved, the piston pressurizes hydraulic fluid, which is indicated by arrows 60 to actuate the brake and provide the braking function. The park pawl 38 is in an unengaged position and the lever 8 can be said to be in an “applied” position.

Referring to FIGS. 6-7, the hydraulic brake system 10 is shown. When the brake lever 8 is in the applied position, and when it is desired to maintain the lever in the applied position, park pawl 38 is rotated about hole 31 in lever 8 in a direction indicated by arrow 62. The park pawl, and more specifically end 64, is engageable with the park pawl engagement section 33 of the handle bar attachment bracket 32 to maintain the brake lever 8 in a locked position when the lever is in the applied position.

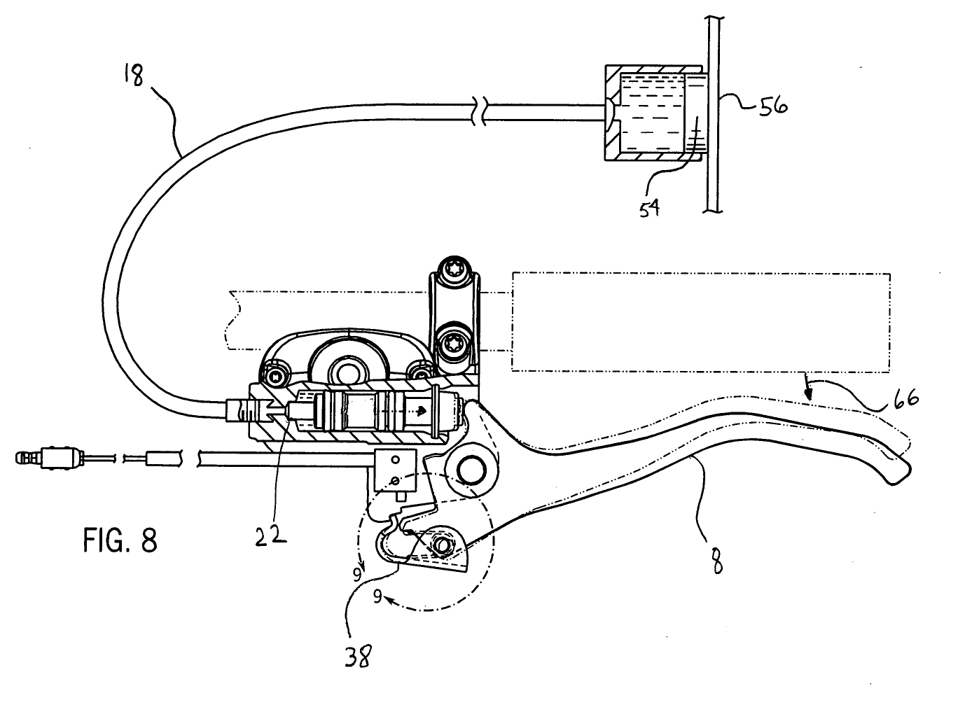

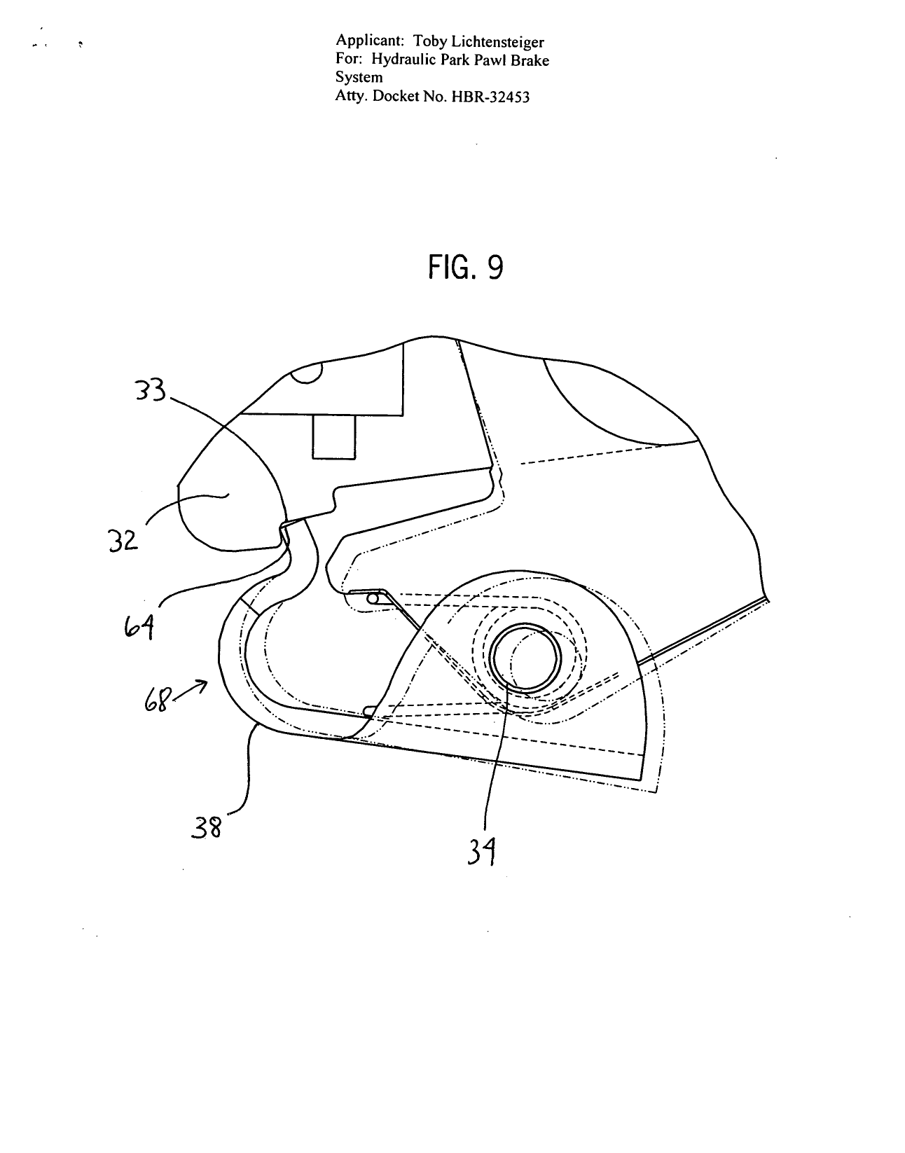

FIG. 8 illustrates the hand operated hydraulic brake system 10 showing the additional movement of the park pawl 38 due to brake fluid expansion due to temperature increase. FIG. 9 is an enlarged view taken along 9-9 of FIG. 8 showing deflection of the park pawl 38 due to brake fluid expansion as a result of temperature increase. Referring to both FIGS. 8-9, when the pawl 38 is in the locked position, a park pawl compensation flexure occurs due to a change in hydraulic fluid temperature. More specifically, it can be seen that, when the park pawl 38 is set so that end 64 engages park pawl engagement section 33 of attachment bracket 32, flexure occurs and is indicated in that the pawl moves from an original position (shown in dashed lines) to a final position. It should be understood that the shapes of, for example, the end 64 and engagement section 33, are selected to ensure a proper securing fit to withstand flexure, but that other shapes are contemplated and within the scope of the present invention.

The volume of hydraulic brake fluid, as noted previously, expands as brake fluid temperature increases and contracts as temperature decreases. As shown, and by way of example, during a brake fluid temperature increase, an expansion of fluid in brake line 18 causes piston 22 to move lever 8 in a direction indicated by arrow 66. Movement of the brake lever 8 creates a force about pin 34, which translates into an additional force upon pawl 38, and particularly, at end 64. Stated another way, the reciprocating master cylinder piston 22 urges the hand brake lever 8 to rotate from the applied position when park pawl compensation flexure occurs.

In response to this increased force, the inventive park pawl, while in the set position as shown, deflects. Significantly, this deflection capability permits the brake to maintain the proper brake line fluid pressure. It can be said that, during temperature increase, the park pawl compensation flexure is a park pawl expansive compensation flexure and that, when the hydraulic fluid incurs a temperature increase, the park pawl absorbs force created by movement of the lever from the applied position due to the expansion of the hydraulic fluid. In this way, the pawl stores the energy resulting from the force exerted upon it. Thus, the park pawl expansively deflects as a result of the lever movement.

Similarly, during a hydraulic brake fluid temperature decrease, the pawl 38 releases its stored energy and urges, via a reverse flexure, the lever 8 to the original set position (shown in dashed lines) when the brake is applied. In a preferred embodiment, there may be minimal functionality of the spring clip 48 during flexure. Rather, the preferred functionality of the spring clip 48 is to hold the park pawl 38 in and return the same to home position (i.e., released). Stated another way, the park pawl compensation flexure can be a park pawl contractive compensation flexure when the hydraulic fluid incurs a temperature decrease. In this way, the park pawl returns energy stored within the pawl that is created by a contraction of the hydraulic fluid. Here, the park pawl contractively deflects as a result of the lever movement. In short, the park pawl compensation flexure can be characterized as one of a park pawl expansive compensation flexure and a park pawl contractive compensation flexure. The expansive and contractive flexures result in opposing park pawl motion. The park pawl expansive compensation flexure and the park pawl contractive compensation flexure compensate for hydraulic fluid temperature changes so as to accommodate movement of the lever when the lever is in the applied position. The park pawl expansive compensation flexure and the park pawl contractive compensation flexure maintain brake pressure.

Section 68 generally of pawl 38 is shown as a generally contoured shape. However, it is contemplated that any shape having, for example, appropriate length, width, curvature and the like are within the scope of the present invention, provided that the section is capable of deflecting and resiliently deflecting back to an original position.

A handle bar master cylinder assembly is disclosed. The assembly has a resilient park pawl capable of flexure to compensate for hydraulic fluid temperature changes in the master cylinder assembly. The assembly supplies pressurized hydraulic fluid through a brake line to actuate a brake in a vehicle. The resilient park pawl can at least partially deflect. The park pawl flexes while engaged to a handle bar attachment bracket connected to the master cylinder at a bracket park pawl engagement section. The bracket park pawl engagement section includes a notched portion.

A method of compensating for a change in hydraulic fluid temperature in a handle bar master cylinder assembly for supplying pressurized hydraulic fluid through a brake line to actuate a brake in a vehicle is disclosed. The method includes providing a master cylinder having a master cylinder body that defines a hydraulic fluid reservoir. The reservoir contains the make-up hydraulic fluid. A reciprocating master cylinder piston is located within the hydraulic fluid reservoir. The piston pressurizes the hydraulic fluid to actuate the brake. A handle bar attachment bracket is connected to the master cylinder body and has a park pawl engagement section. A hand brake lever is rotatably secured to the handle bar attachment bracket and is in abutting contact with the reciprocating master cylinder piston. The lever is rotatable to an applied position for braking of the vehicle. A park pawl is pivotably secured to the hand brake lever. The park pawl includes an end that is engageable with the park pawl engagement section of the handle bar attachment bracket to maintain the brake lever in the applied position. When the pawl is in the set position, the park pawl is capable of a compensation flexure that occurs due to a change in the hydraulic fluid temperature. The flexing can further comprise expansively deflecting the park pawl as a result of the lever movement. The flexing can further comprise contractively deflecting the park pawl as a result of the lever movement. Significantly, the flexing capability ensures or maintains a substantially constant pressure within the master cylinder body despite a change in at least one of hydraulic fluid volume and temperature.

The inventive park pawl is an improvement over the previous park pawl designs. The park pawl has a deflection (i.e., spring-like) capability such that when the hydraulically held park brake is set by introducing the park pawl into engagement to hold the service brake in the “on” position, the force from the service brake lever (due to the hydraulic pressure created by the operator moving the lever to the desired position) deflects the park pawl slightly so that there is stored energy in the park pawl. When the temperature drops so that the brake fluid contracts, the stored energy from the park pawl allows fluid to replenish some of the volume of the contracted fluid and allows significantly more pressure to be retained in the brake system than with a park pawl that has no flexibility. This occurs since, in previous park pawl designs, as the fluid contracts, there is no spring in the park pawl to deliver energy back to the brake system. Furthermore, when the brake fluid expands as the temperature of the brake fluid increases, the inventive park pawl allows energy to be stored in the park pawl, limiting the rise of brake pressure, and therefore, reducing the chance of damage to the system from excessive pressure.

Despite any methods being outlined in a step-by-step sequence, the completion of acts or steps in a particular chronological order is not mandatory. Further, modification, rearrangement, combination, reordering, or the like, of the acts or steps is contemplated and considered within the scope of the description and claims.

Various alternatives and embodiments are contemplated as being within the scope of the following claims particularly pointing out and distinctly claiming the subject matter regarded as the invention.

What is claimed is:

1. A handle bar master cylinder assembly for supplying pressurized hydraulic fluid through a brake line to actuate a brake in a vehicle, the assembly comprising
a master cylinder having a master cylinder body defining a hydraulic fluid reservoir, the reservoir for containing the hydraulic fluid,
a reciprocating master cylinder piston located within the hydraulic fluid reservoir, the piston for pressurizing the hydraulic fluid to actuate the brake;
a handle bar attachment bracket connected to the master cylinder body and having a park pawl engagement section;
a hand brake lever rotatably secured to the handle bar attachment bracket and in abutting contact with the reciprocating master cylinder piston, the lever rotatable to an applied position for braking of the vehicle; and
a park pawl pivotably secured to the hand brake lever, the park pawl having an end engageable with the park pawl engagement section of the handle bar attachment bracket to maintain the brake lever in the applied position;
wherein, when the pawl is set, a park pawl compensation flexure occurs due to a change in hydraulic fluid temperature.

2. The assembly of claim 1 wherein the reciprocating master cylinder piston urges the hand brake lever to rotate from the applied position when park pawl compensation flexure occurs.

3. The assembly of claim 1 wherein the park pawl compensation flexure is a park pawl expansive compensation flexure such that, when the hydraulic fluid incurs a temperature increase, the park pawl absorbs force created by movement of the lever from the applied position due to the expansion of the hydraulic fluid.

4. The assembly of claim 3 where in the park pawl expansively deflects as a result of the lever movement.

5. The assembly of claim 1 wherein the park pawl compensation flexure is a park pawl contractive compensation flexure such that, when the hydraulic fluid incurs a temperature decrease, the park pawl returns energy stored within the pawl that is created by a contraction of the hydraulic fluid.

6. The assembly of claim 5 wherein the park pawl contractively deflects as a result of the lever movement.

7. The assembly of claim 1 wherein the park pawl compensation flexure is one of a park pawl expansive compensation flexure and a park pawl contractive compensation flexure and the expansive and contractive flexures result in opposing park pawl motion.

8. The assembly of claim 1 wherein the handle bar attachment bracket includes a notched portion and the park pawl engages the notched portion.

9. The assembly of claim 7 wherein the park pawl expansive compensation flexure and the park pawl contractive compensation flexure compensate for hydraulic fluid temperature changes so as to accommodate movement of the lever when the lever is in the applied position.

10. The assembly of claim 7 wherein the park pawl expansive compensation flexure and the park pawl contractive compensation flexure maintain brake pressure.

11. A handle bar master cylinder assembly having a resilient park pawl capable of flexure to compensate for hydraulic fluid temperature changes in the master cylinder assembly, the assembly for supplying pressurized hydraulic fluid through a brake line to actuate a brake in a vehicle.

12. The assembly of claim 11 wherein the resilient park pawl can at least partially deflect.

13. The assembly of claim 12 wherein the park pawl flexes while engaged to a handle bar attachment bracket connected to the master cylinder at a bracket park pawl engagement section.

14. The assembly of claim 13 wherein the bracket park pawl engagement section includes a notched portion.

15. A retrofit assembly for use with a handle bar master cylinder assembly for supplying pressurized hydraulic fluid through a brake line to actuate a brake in a vehicle, the retrofit assembly comprising a resilient park pawl capable of flexure to compensate for hydraulic fluid temperature changes in the master cylinder assembly.

16. The retrofit assembly of claim 15 wherein the resilient park pawl can at least partially deflect.

17. The assembly of claim 16 wherein the park pawl flexes while engaged to a handle bar attachment bracket connected to the master cylinder at a bracket park pawl engagement section.

18. The assembly of claim 17 wherein the bracket park pawl engagement section includes a notched portion.

19. A method of compensating for a change in hydraulic fluid temperature in A handle bar master cylinder assembly for supplying pressurized hydraulic fluid through a brake line to actuate a brake in a vehicle, the method comprising:
providing a master cylinder having a master cylinder body defining a hydraulic fluid reservoir, the reservoir for containing the hydraulic fluid, a reciprocating master cylinder piston located within the hydraulic fluid reservoir, the piston for pressurizing the hydraulic fluid to actuate the brake; a handle bar attachment bracket connected to the master cylinder body and having a park pawl engagement section; a hand brake lever rotatably secured to the handle bar attachment bracket and in abutting contact with the reciprocating master cylinder piston, the lever rotatable to an applied position for braking of the vehicle; and a park pawl pivotably secured to the hand brake lever, the park pawl having an end engageable with the park pawl engagement section of the handle bar attachment bracket to maintain the brake lever in the applied position; and
when the pawl is in a set position, flexing the park pawl to achieve a park pawl compensation flexure that occurs due to a change in the hydraulic fluid temperature.

20. The method of claim 19 wherein the flexing further comprises expansively deflecting the park pawl as a result of the lever movement.

21. The method of claim 19 wherein the flexing further comprises contractively deflecting the park pawl as a result of the lever movement
